(19) United States
(12) Patent Application Publication
(10) Pub. No.: US 2017/0105077 A1
(43) Pub. Date: Apr. 13, 2017

(54) COMPACT HOUSING ASSEMBLY OR FACEPLATE LAYOUT

(71) Applicant: Sonion A/S, Roskilde (DK)

(72) Inventors: Tobias Theilman Rasmussen, Hoofddorp (NL); Anders Larsen, Hoofddorp (NL); Jais Andreas Breusch Angel, Hoofddorp (NL); Søren Ravnkilde, Hoofddorp (NL); Gert Plenge, Hoofddorp (NL)

(21) Appl. No.: 15/290,594

(22) Filed: Oct. 11, 2016

(30) Foreign Application Priority Data
Oct. 13, 2015 (EP) 15189559.6

(51) Int. Cl. H04R 25/00

(52) U.S. Cl. CPC H04R 25/65; H04R 25/405; H04R 25/604; H04R 25/602; H04R 2225/021; H04R 2225/023; H04R 2225/025

(57) ABSTRACT

A housing assembly for a hearing device. The housing assembly includes a connection area within which connection area a connection mechanism for an associated lid is provided, the connection area further comprising one or more sound inlet openings being configured to be acoustically connected to one or more microphones of the housing assembly. A hearing device including such a housing assembly is also contemplated.

### CROSS-REFERENCE TO RELATED APPLICATION

This application claims the benefit of European Patent Application Serial No. 15189559.6, filed Oct. 13, 2015, and titled “Compact Housing Assembly or Faceplate Layout,” which is incorporated herein by reference in its entirety.

### FIELD OF THE INVENTION

The present invention relates to a compact housing assembly or faceplate layout. In particular, the present invention relates to a housing assembly or faceplate layout where the functionalities of a plurality of housing assembly or faceplate components are combines in order to save space, such as faceplate area.

### BACKGROUND OF THE INVENTION

It is well-known that hearing devices are getting smaller and smaller. In particular, the so-called completely-in-canal (CIC) is an extremely compact device with only very little area being available on its faceplate.

Therefore, there is a need for very compact housing assembly or faceplate layouts where the functionalities of different components are combined within the same faceplate area.

It may be seen as an object of embodiments of the present invention to provide a compact housing assembly or faceplate layout.

It may be seen as a further object of embodiments of the present invention to provide a compact housing assembly or faceplate layout where sound inlet openings to microphones are arranged in a space saving manner.

### SUMMARY OF INVENTION

The above-mentioned objects are complied with by providing, in a first aspect, a housing assembly for a hearing device, said housing assembly comprising a connection area within which connection area a connection mechanism for an associated lid is provided, the connection area further comprising one or more sound inlet openings being configured to be acoustically connected to one or more microphones of the hearing assembly, said one or more microphones being at partly positioned below the connection mechanism in order to save space.

The housing assembly of the present invention may be seen as at least part of a housing of a hearing device, such as a hearing aid. Depending on the type of hearing aid the housing assembly may be considered a faceplate. The housing assembly of the present invention is intended for use in relation with hearing devices, such as hearing aids. The hearing aid may in principle be any type of hearing aid, including hearing types like behind-the-ear, in-the-ear, in-the-canal, invisible-in-canal and completely-in-canal.

The housing assembly of the present invention offers a very compact housing assembly layout where the arrangement of one or more sound inlet openings are combined with the connection area of the housing assembly, i.e. the area within which a connection mechanism or arrangement is provided. The connection mechanism or arrangement is adapted to connect the housing assembly to an associated lid in a desired manner. The lid may in principle be any kind of lid, such as for example a battery door.

The one or more sound inlet openings may be implemented as through-going holes in the housing assembly. The sound that enters the one or more sound inlet openings may be led via sound conduits or channels to one or more microphones of the hearing device. The microphones may in principle be any type of microphones, such as electret microphones or MEMS microphones.

The sound inlet opening and the one or more microphones may be mutually connected via a sound conduit or channel being at partly positioned below the connection mechanism. This arrangement is advantageous seen from a space saving perspective.

The connection mechanism may comprise a hinge pin around which hinge pin the associated lid is adapted to pivot. The hinge pin may be discrete component, such as a metal rod, or it may form an integral part of the connection mechanism. Even further, the connection mechanism may form an integral part of the housing assembly. For example, the housing assembly and the connection mechanism may be an injection moulded one-piece component.

Alternatively, the connection mechanism forms a discrete and detachable part from the housing assembly. In this configuration, the connection mechanism may be manufactured separately and subsequently fastened to the housing assembly using suitable fastening means, such as screws.

The connection mechanism may be adapted to be arranged essentially symmetrically relative to the associated lid. The term essentially symmetrically is here to be taken as if the connection mechanism is arranged in a symmetrical manner relative to a longitudinal centre axis of the lid. In this arrangement the hinge pin may, in its longitudinal direction, be arranged between two sound inlet openings being configured to be acoustically connected to a directional microphone or two omni-directional microphones. Thus, the hinge pin and the two sound inlet openings may be positioned along a line. Moreover, the two sound inlet openings may form part of the connection mechanism.

Alternatively, a sound inlet opening may be arranged at least partly below the hinge pin, said sound inlet opening being configured to be acoustically connected to an omni-directional microphone. In this arrangement a sound passage is provided below the hinge pin.

As an alternative to the symmetrically arranged connection mechanism, the connection mechanism may be adapted to be arranged asymmetrically relative to the associated lid, i.e. off-axis compared to the longitudinal centre axis of the lid. With the connection mechanism being off-set a sound inlet opening may be arranged in a longitudinal direction of the hinge pin, said sound inlet opening being configured to be acoustically connected to an omni-directional microphone.

When applying a hinge pin as described above the associated lid becomes pivotally mounted relative to the housing assembly. However, other types of connection arrangement are applicable. For example the connection mechanism may comprise a guiding pin along which guiding pin the associated lid is slidable. The guiding pin may be secured to the housing assembly at one end while the opposite end may comprise a mechanical end stop. The guiding pin may be configured to engage with the associated lid via a through-going opening arranged therein. Thus, the guiding pin thus acts as a steer for the associated lid. Two sound inlet openings may be arranged on opposing sides of the guiding pin, the two sound inlet openings being configured to be acoustically connected to a directional microphone or two omni-directional microphones.

The connection mechanism may comprise a snap fit locking mechanism for retaining the associated lid in a closed position. The snap fit locking mechanism may be purely mechanical. To unlock the associated lid from its closed position a certain amount of human force is required.

The housing assembly may further comprise a filter being at least partly positioned in one or more sound inlet openings. The filter may prevent that wax or other impurities enter the sound inlet openings.

In a second aspect the present invention relates to a hearing device comprising a housing assembly according to the first aspect, said hearing device comprising a hearing aid being selected from the group consisting of: behind-the-ear, in-the-ear, in-the-canal, invisible-in-canal and completely-in-canal.

The one or more microphones may comprise one or more MEMS microphones, wherein each MEMS microphone may have a sound inlet opening being arranged in a printed circuit board (PCB) of the MEMS microphone. The PCB of the MEMS microphone may comprise a flexible PCB, such as a flexprint. In order to save space the one or more MEMS microphones may be arranged at an acute angle relative to a faceplate of the hearing device. By positioning the one or more MEMS microphones in an acute angle relative to a faceplate at least part of the one or more microphones may be positioned below the connection mechanism.

### BRIEF DESCRIPTION OF THE DRAWINGS

The present invention will now be described in further details with reference to the accompanying figures, wherein

FIG. 1 shows various views of a connection mechanism with integrated sound inlet openings,

FIG. 2 shows a cross-sectional view of a symmetric connection mechanism,

FIG. 3 shows an asymmetric connection mechanism,

FIG. 4 shows a symmetric connection mechanism,

FIG. 5 shows a connection mechanism using a guiding pin,

FIG. 6 shows another symmetric connection mechanism, and

FIG. 7 shows a symmetric connection mechanism with a filter arrangement.

While the invention is susceptible to various modifications and alternative forms specific embodiments have been shown by way of examples in the drawings and will be described in details herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF PREFERRED EMBODIMENTS

In its broadest aspect the present invention relates to a housing assembly, such as a faceplate, where a number of sound inlet openings are arranged in connection with a connection mechanism for attaching an associated lid to the faceplate. In the following the housing assembly will be referred to as a faceplate. The connection mechanism may either form an integral part of the faceplate or it may be a discrete component being separable from the faceplate. The aim of positioning the sound inlet openings in connection with the connection mechanism is to increase the area of free faceplate. The associated lid may in principle be any kind of lid, such as for example a battery door.

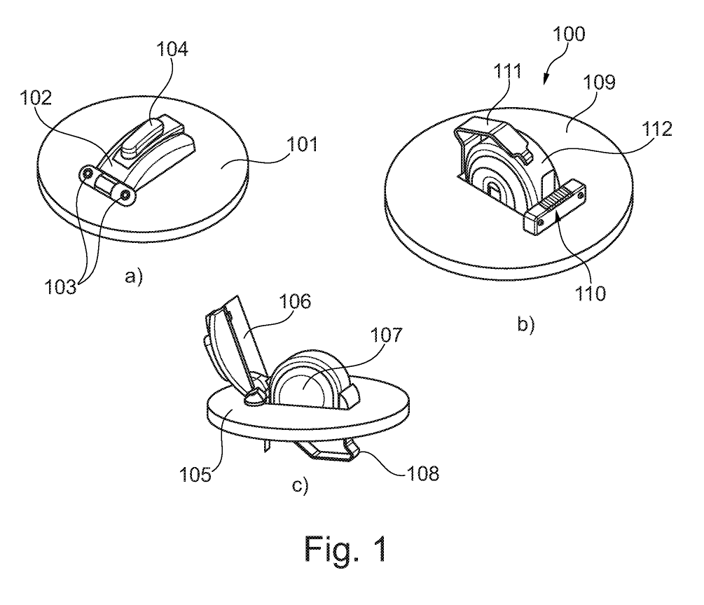

Referring now to FIG. 1 a first embodiment 100 of the present invention is depicted. As seen in FIG. 1a a lid 102 in the form of a battery door is hinged to the faceplate 101 via a connection mechanism having two sound inlet openings 103 arranged therein. The lid 102 includes a push button 104 intended for switching programs in a device of which the faceplate forms part. Such a device may be a hearing device, such as a hearing aid. As illustrated in FIG. 1b the battery door 106 is pivotally hinged to the faceplate 105 via the connection mechanism. Upon opening of the battery door 106 a resilient member 108 pushes/moves the battery 107 to a position where it may be removed by the user. Returning to FIG. 1a, and as mentioned before, the connection mechanism that hinges the battery door 102 to the faceplate 101 includes two sound inlet openings 103. By incorporating the sound inlet openings 103 into the connection mechanism important faceplate space is saved. The sound inlet openings 103 are acoustically connected to a directional microphone 110 being secured to the faceplate 109 from below, cf. FIG. 1c where the faceplate has been turned upside down. In FIG. 1c the resilient member 111 and the battery 112 is also depicted. Instead of a directional microphone the two sound inlet openings may be acoustically connected to two omni-directional microphones (not shown).

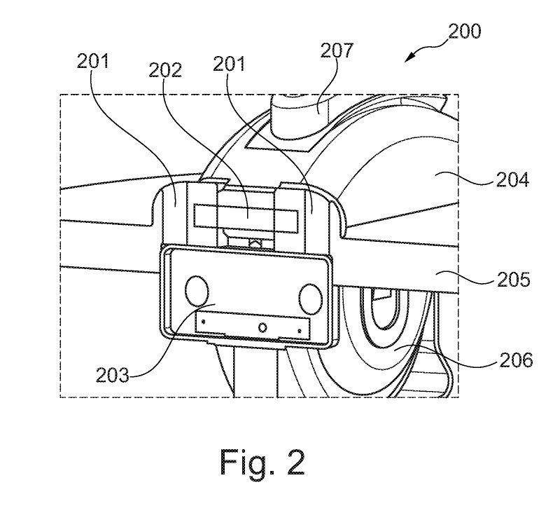

Turning now to FIG. 2 a cross-sectional view of the connection mechanism 200 is depicted. Beside the connection mechanism the faceplate 205, the battery 206, the battery door 204 and the push button 207 is also depicted in FIG. 2. The battery door 204 is pivotally mounted around hinge pin 202. On each side of the hinge pin 202 a sound inlet opening 201 is arranged. The sound inlet openings 201 lead sound from the exterior to the directional microphone 203 being secured to the faceplate 205 from below. Optionally the directional microphone 203 can be replaced by two omni-directional microphones. As seen the sound inlet openings 201 are integrated in the connection mechanism. The connection mechanism may form an integral part of the faceplate, or it may be a discrete component being separable from the faceplate. Also, the hinge pin 202 may form an integral part of the connection mechanism or it may be a discrete component, such as a metal rod. As depicted in FIGS. 1 and 2 the battery door is hinged to the faceplate in a symmetric manner, i.e. symmetrically around a longitudinal center axis of the battery door.

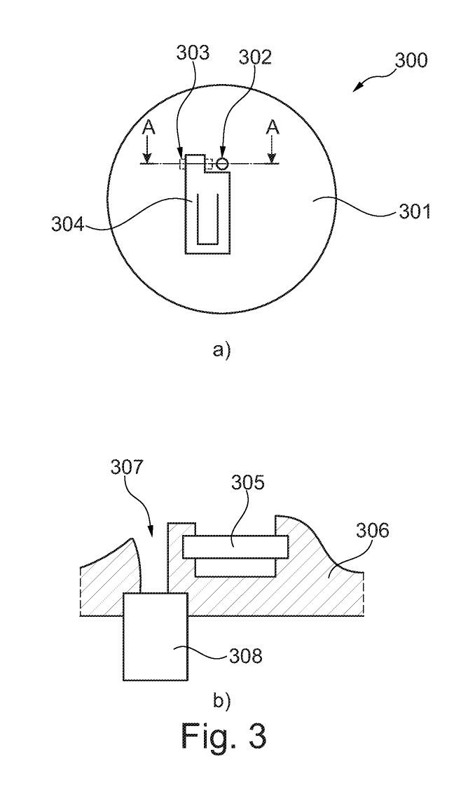

In FIG. 3a an embodiment 300 with an asymmetrically hinged battery door 304 is depicted. As seen from the top view depicted in FIG. 3a the battery door 304 is hinged to the hinge pin 303 only at the left side of the battery door 304. By hinging the battery door in this asymmetric manner, important space becomes available next to the connection mechanism. In FIG. 3a this important space becomes available to the right of the connection mechanism including the hinge pin 303. As seen in FIG. 3a a sound inlet opening 302 is positioned in the region just next to the connection mechanism including the hinge pin 303. The sound inlet opening 302 is acoustically connected to an omni-directional microphone being positioned below the faceplate 301. In FIG. 3b a cross-sectional view of the connection mechanism is depicted. The cross-sectional view of FIG. 3b follows the AA-line in FIG. 3a. The hinge pin 305, which may be a discrete component, such as a metal hinge pin, is secured to the faceplate 306. Alternatively, the hinge pin 305 may form an integral part of the connection mechanism and thereby an integral part of the faceplate. The sound inlet opening 307 allows incoming sound to reach the omni-directional microphone 308 which is fastening to the faceplate 306 from below.

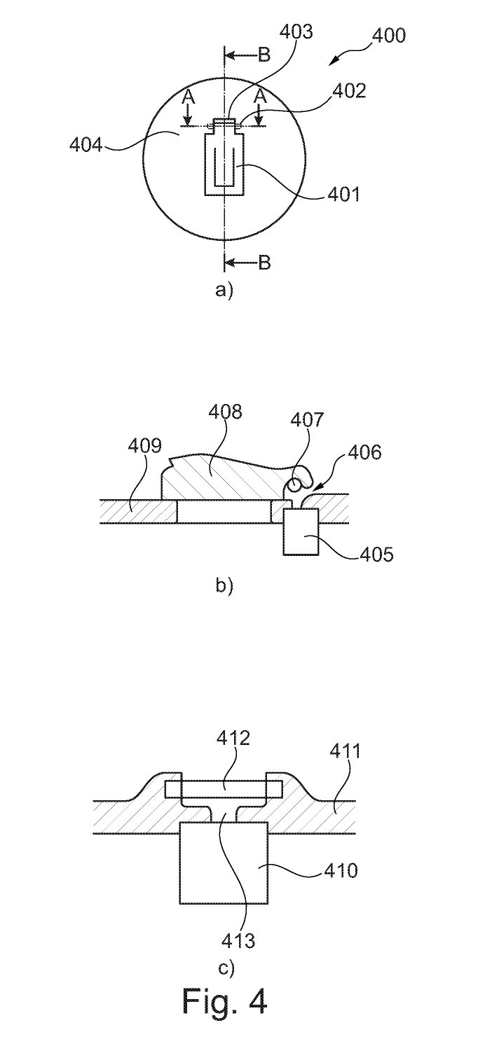

In the embodiment shown in FIG. 4a-c a sound inlet opening 406, 413 is positioned below a hinge pin in order to take up minimum faceplate space. Referring now to FIG. 4a a top view of faceplate 404 and a battery door 401 is depicted. The battery door 401 is symmetrically hinged to the faceplate 404 at hinge pin 402. The sound inlet opening 403 is positioned below the hinge pin 402 and it is therefore not visible in FIG. 4a. The hidden sound inlet opening is however clearly seen in the cross-sectional view of FIG. 4b (along line BB) where the sound inlet opening 406 is positioned below the hinge pin 407 so that sound is able to reach the omni-directional microphone 405. The faceplate 409 and battery door 408 are also shown in FIG. 4b. Another cross-sectional view (along line AA) is depicted in FIG. 4c. Here the sound inlet opening 413 is positioned below the hinge pin 412 whereby sound is allowed to reach the omni-directional microphone 410. Similar to the previous embodiments the hinge pin 412 is either secured to the faceplate 411 or integrated therewith.

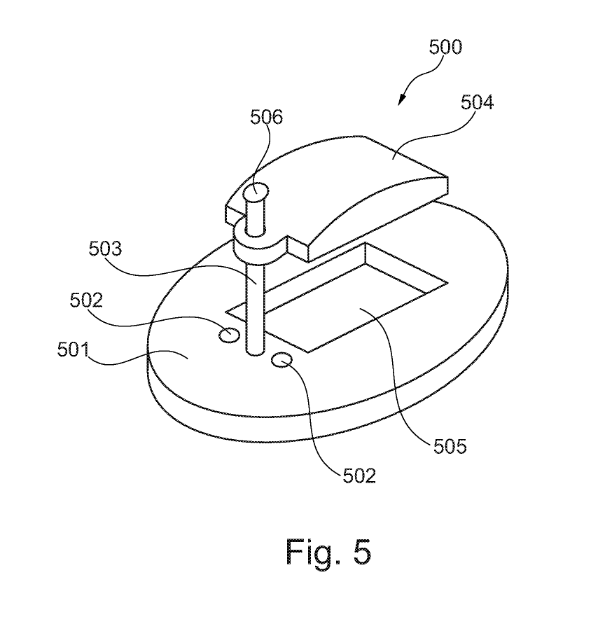

FIG. 5 shows a different embodiment 500 where the battery door 504 is adapted to perform a translational movement along the guiding pin 503 during opening and closing. The guiding pin 503, which steers the associated lid via a through-going opening arranged therein, includes a mechanical end stop 506 for preventing that the battery door 504 unintendedly leaves the guiding pin. The guiding pin 503 is secured to the faceplate 501 with suitable fastening means. Two sound inlet openings 502 are arranged next to the guiding pin 503. These sound inlet openings 502 are acoustically connected to either a directional microphone or to omni-directional microphones (not shown). A through-going opening 505 is provided in the faceplate to allow passage of a cell-type battery.

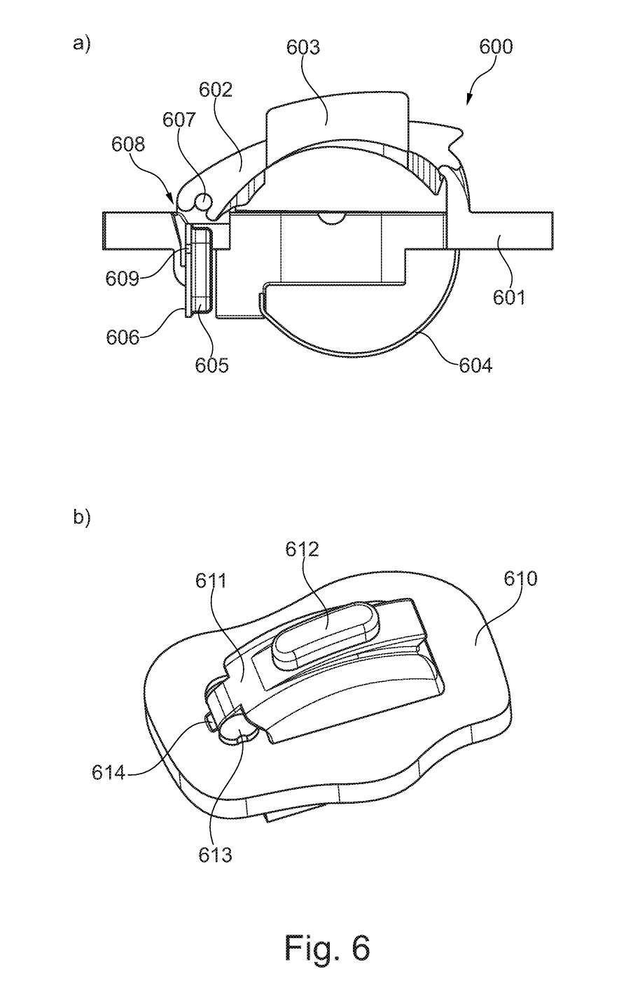

FIG. 6a shows a cross-section view of an embodiment 600 that applies a MEMS microphone 605 being mounted directly under the pivot point of the hinge 607. The MEMS microphone 605 is at least partly encapsulated in a housing, such as a metal housing. The MEMS microphone including its housing is arranged on a PCB 606 having a sound inlet opening 609 arranged therein. As depicted in FIG. 6a a sound conduit 608 is provided through the faceplate 601 so that incoming sound is guided to the sound inlet opening 609 in the PCB 606 of the MEMS microphone 605. The sound inlet opening 609 may comprise a mesh in order to form a resistive element and thus provide a predetermined damping. In addition, the PCB 606 may be a flexible PCB whereby the electrical contacts of the MEMS microphone 605 may easily be located at the sides of the microphone.

In the embodiment depicted in FIG. 6a the faceplate 601 and the MEMS microphone 605 are arranged essentially perpendicular to each other. FIG. 6a further shows a pivotable lid 602 having a release button 603 arranged therein. Moreover, at support structure 604 for supporting a battery is provided.

FIG. 6b shows a top view of the embodiment shown in FIG. 6a. FIG. 6b thus shows the faceplate 610, the pivotable lid 611, the hinge 613 and the release button 612. Moreover, the opening 614 of the sound conduit, cf. reference numeral 608 in FIG. 6a, is shown right in front of the hinge 613. The opening 614 of the sound conduit as well as the sound conduit itself is symmetric with respect to the hinge 613 and a pivotable lid 611.

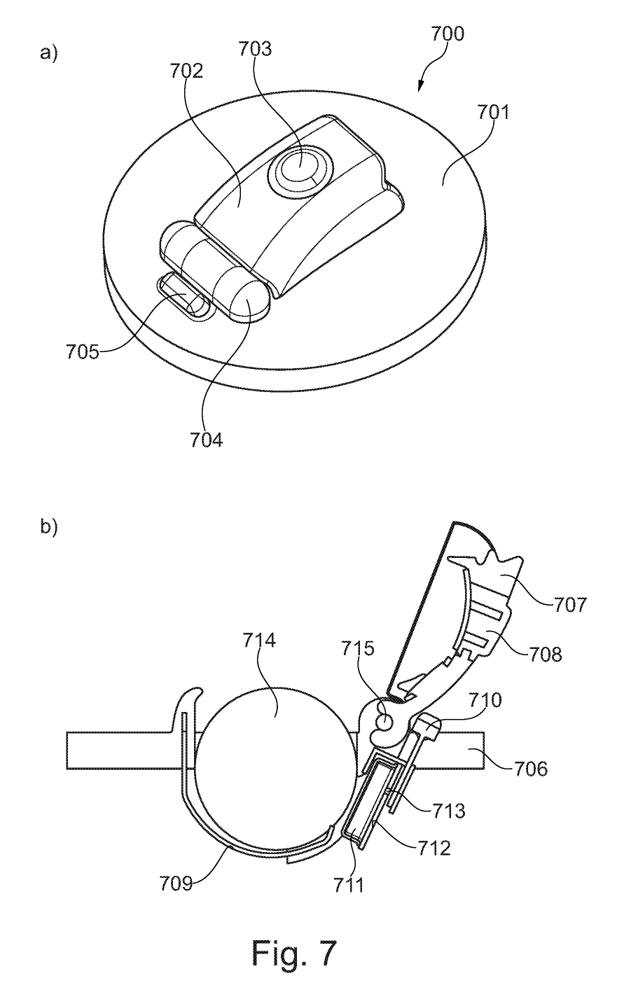

Turning now to FIG. 7a a top view of yet another embodiment is depicted. FIG. 7a shows a faceplate 701 having a pivotable lid 702 attached thereto via a hinge arrangement 704. A release button 703 is integrated in the pivotable lid 702. A sound inlet opening with a filter 705 inserted therein is provided right in front of the hinge arrangement 704.

Referring now to FIG. 7b a cross-sectional view of the embodiment shown in FIG. 7a is depicted. Again, the faceplate 706, the pivotable lid 707 and the release button 708 is depicted. Moreover, FIG. 7b shows a support structure 709 for holding the battery 714 as well as a MEMS microphone 711 being arranged below the pivot axis 715. Similar to the MEMS microphone shown in FIG. 6a the MEMS microphone 711 comprises a housing. The MEMS microphone including its housing is arranged on a PCB 712 having a sound inlet opening 713 arranged therein. As previously addressed the sound inlet opening 713 may form a resistive element and thus provide a predetermined damping. In addition, the PCB 712 may be a flexible PCB whereby the electrical contacts of the MEMS microphone 711 may easily be located at the sides of the microphone.

As depicted in FIG. 7b a sound conduit with a filter 710 inserted therein is provided through the faceplate 706 so that incoming sound is guided to the sound inlet opening 713 in the PCB 712 of the MEMS microphone 711. As seen in FIG. 7b the sound conduit as well as the MEMS microphone are not perpendicular the faceplate in that at least part of the MEMS microphone 711 is positioned below the battery 714. The filter 710 prevents that wax and other impurities enter and thereby block the sound conduit and/or the sound inlet opening 713. The filter may be implemented in various ways, including various mesh structures.

The various embodiments of the present invention have been disclosed in relation to a faceplate having a battery door attached thereto. The aim of the present invention is the position one or more sound inlet openings in relation to a connection mechanism that connects the battery door to the faceplate in order to free faceplate area. It should be noted however, that the principle of the present invention is also applicable in relation to other types of lids being connected to a faceplate.

1. A housing assembly for a hearing device, said housing assembly comprising a connection area within which connection area a connection mechanism for an associated lid is provided, the connection area further comprising one or more sound inlet openings being configured to be acoustically connected to one or more microphones of the housing assembly, said one or more microphones being at partly positioned below the connection mechanism in order to save space.

2. A housing assembly according to claim 1, wherein the sound inlet opening and the one or more microphones are mutually connected via a sound conduit being at partly positioned below the connection mechanism.

3. A housing assembly according to claim 1, wherein the connection mechanism comprises a hinge pin around which hinge pin the associated lid is adapted to pivot.

4. A housing assembly according to claim 3, wherein the connection mechanism forms an integral part of the housing assembly.

5. A housing assembly according to claim 3, wherein the connection mechanism is adapted to be arranged essentially symmetrically relative to the associated lid.

6. A housing assembly according to claim 3, wherein the hinge pin, in its longitudinal direction, is arranged between two sound inlet openings being configured to be acoustically connected to a directional microphone or two omni-directional microphones.

7. A housing assembly according to claim 6, wherein the two sound inlet openings form part of the connection mechanism.

8. A housing assembly according to claim 3, wherein a sound inlet opening is arranged at least partly below the hinge pin, said sound inlet opening being configured to be acoustically connected to an omni-directional microphone.

9. A housing assembly according to claim 3, wherein the connection mechanism is adapted to be arranged asymmetrically relative to the associated lid.

10. A housing assembly according to claim 9, wherein a sound inlet opening is arranged in a longitudinal direction of the hinge pin, said sound inlet opening being configured to be acoustically connected to an omni-directional microphone.

11. A housing assembly according to claim 1, wherein the connection mechanism comprises a guiding pin along which guiding pin the associated lid is slidable.

12. A housing assembly according to claim 11, wherein two sound inlet openings are arranged on opposing sides of the guiding pin, the two sound inlet openings being configured to be acoustically connected to a directional microphone or two omni-directional microphones.

13. A housing assembly according to claim 1, further comprising a filter at least partly positioned in one or more sound inlet openings.

14. A hearing device comprising a housing assembly according to claim 1, said hearing device comprising a hearing aid being selected from the group consisting of: behind-the-ear, in-the-ear, in-the-canal, invisible-in-canal and completely-in-canal.

15. A hearing device according to claim 14, wherein the one or more microphones comprise one or more MEMS microphones, wherein each MEMS microphone has a sound inlet opening being arranged in a PCB of the MEMS microphone.

16. A hearing device according to claim 15, wherein the PCB of the MEMS microphone comprises a flexible PCB, such as a flexprint.

17. A hearing device according to claim 15, wherein the one or more MEMS microphones are arranged at an acute angle relative to a faceplate of the hearing device.
